(19) United States
(12) Patent Application Publication
(10) Pub. No.: US 2014/0350990 A1
(43) Pub. Date: Nov. 27, 2014

(54) Simulated Print Demand

(71) Applicants: Jun Zeng, Sunnyvale, CA (US); Jun Li, Mountain View, CA (US)

(72) Inventors: Jun Zeng, Sunnyvale, CA (US); Jun Li, Mountain View, CA (US)

(21) Appl. No.: 14/347,343

(22) PCT Filed: Feb. 7, 2012
(86) PCT No.: PCT/US2012/024096

§ 371 Date: Mar. 26, 2014

(51) Int. Cl. G06Q 10/06; G06Q 30/02

(52) U.S. Cl. CPC G06Q 10/06313; G06Q 30/0251; G06Q 30/0202
USPC 705/7.23

(57) ABSTRACT

A computer readable memory (8) having machine readable instructions can comprise a simulation engine (20) to receive project data characterizing a project of a print buyer (5). The project can comprise a production of printed material. The simulation engine (20) can also generate a simulated print demand that characterizes a print demand for the printed material for the project. The simulation engine (20) can generate print service provider (PSP) simulation results based on print demand data that includes an actual print demand provided from a plurality of print buyers (5) or the simulated print demand generated for the project. The machine readable instructions can also comprise an analyzer (22) to identify a PSP (18) of a plurality of PSPs (18) based on a simulated fulfillment of the print demand at each of the plurality of PSPs (18).

### BACKGROUND

A component to a commercial print value-creation chain can be a service engagement and fulfillment between content suppliers (e.g., service buyers) and the print service providers (PSPs). A PSP can be a factory that manufactures print products. In some examples, a PSP can lease its manufacturing capability as a form of a utility service. Service products offered by PSPs are diverse. Such products include physical products produced by printing. The products can vary from photographs and brochures, course materials, periodicals and books, to advertisements and product packaging. In some examples, the products can also include ancillary services, for example, upstream of a fulfillment value chain the ancillary services can include content creation, content orchestration, and prototyping. Such ancillary services may additionally or alternatively be downstream of the fulfillment value chain and can include shipping and local installation (for example, for large format posters to be installed at a show window of a department store). The service buyers can also be relatively diverse. The service buyers can include consumers, consumer-facing specialty services, creative agencies, and enterprises. In some examples, enterprise marketing operations and the associated content creation activities can drive a significant share of printed material.

### BRIEF DESCRIPTION OF THE DRAWINGS

FIG. 1 illustrates an example of a system for matching a print buyer's project with a print service provider.

FIG. 2 illustrates an example of a simulation engine.

FIG. 3 illustrates an example of an analyzer.

FIG. 4 illustrates an example of a marketplace system.

FIG. 5 illustrates an example of a flow chart of a method for generating a simulated print buyer's project.

FIG. 6 illustrates an example of a flowchart of a method for managing a request for PSP market data.

FIG. 7 illustrates an example of a computer readable medium with machine readable instructions for simulating a print demand.

FIG. 8 illustrates an example of a flowchart of a method for simulating a print demand.

### DETAILED DESCRIPTION

A print service buyer (which can also be referred to as a print buyer) has needs for print products of a certain kind to fulfill business purposes. For example, a marketing department of an enterprise can be a print buyer. The marketing department can conduct a project to launch a marketing campaign. Such a marketing campaign may need a large quantity of high-quality grand-format graphic art posters. A print buyer's project describes the actions needed to complete the project and the inter-dependencies between such actions. In such a situation, printing can be such an action. The buyer's print project can also describe a lead time and budget of the project.

A print demand can refer to the quantity and quality of desired print products for the print buyer's project. The print demand can also include a form factor, substrate and other details (also known as order intent). A print buyer may prefer to engage (e.g., contract) with a print service provider (PSP) to produce the print products, since for example, the print buyer may not have the necessary print expertise and/or printing equipment to print the products for the print buyer's project. Additionally or alternatively, it may be more cost efficient and/or less time consuming for the PSP to produce the print products for the print buyer's project. A print buyer may also prefer to engage with a PSP to handle printing related ancillary tasks such as content creation, content orchestration, prototyping, shipping and local installation. A print buyer may elect to employ these ancillary services provided by a PSP since the PSP may possess related expertise. Additionally or alternatively, it may be less time consuming and/or more cost efficient to employ the ancillary services provided by the PSP.

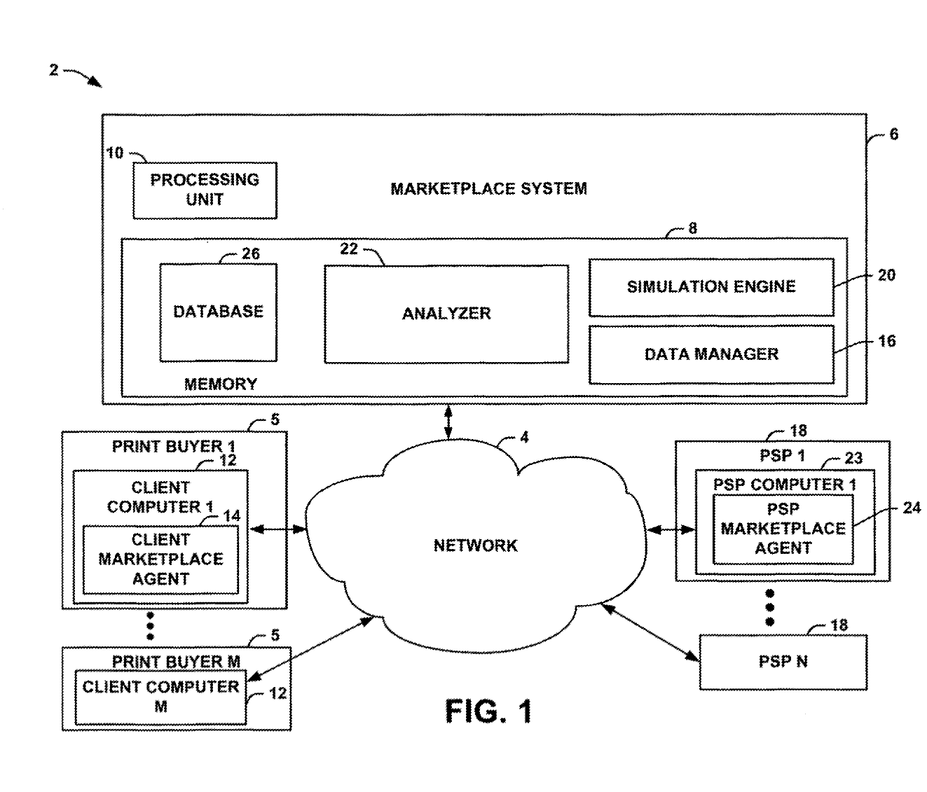

FIG. 1 illustrates an example of a system 2 for matching a print buyer's project with a (PSP) over a network 4. A print buyer's project could be implemented, for instance, as a marketing campaign, production of a trade magazine, production of course materials or the like. The print buyer's project can be implemented as a multi-phase production that can include printing of materials. The print buyer's project can include a print demand that requests a relatively large and/or complex print job, such as high-quality graphic arts for advertising, a book and/or magazine printing. Additionally or alternatively, the print demand can request that certain ancillary services be performed, such as art work orchestration, shipping and/or the installation of printed materials at various sites. A print buyer's project can be associated with an organization (e.g., a person, a business, a charity or the like), which can be referred to as a print buyer 5 or a service buyer. In the present examples, there are M number of print buyers 5, where M is an integer greater than or equal to one. In some examples, the print demand can include, for example, a print on demand request. The network 4 could be implemented, for example as a network that employs the Transmission Control Protocol/Internet Protocol (TCP/IP), Internet Protocol version 6 (IPv6) or the like. In some examples, the network 4 could be implemented as the Internet, and/or a mobile network. A marketplace system 6 can be coupled to the network 4 and can communicate with other nodes on the network 4.

The marketplace system 6 can include a memory 8 for storing machine readable instructions and a processing unit 10 for accessing the memory 8 and executing the machine readable instructions. The memory 8 could be implemented, for example, as volatile memory (e.g., random access memory) or nonvolatile memory (e.g., a hard drive, flash memory or the like). The processing unit 10 can include a processor core.

The marketplace system 6 can communicate with M number of client computers 12 via the network 4, wherein each client computer 12 is situated with a corresponding print buyer 5. In the present examples, only the details of the first print buyer 5 and the corresponding client computer 12 (client computer 1) are described in detail, but it is to be understood that the 2-M number of client computers 12 can be implemented in a manner similar to the first client computer 12. Each client computer 12 can be operated by a user associated with a print buyer 5 associated with a corresponding print buyer's project. The first client computer 12 can include a client marketplace agent 14 executing thereon. In some examples, the client marketplace agent 14 can be implemented on a web browser, (e.g., as a plug-in). The client marketplace agent 14 of the first client computer 12 can provide an interface to the marketplace system 6. In some examples, the client marketplace agent 14 can provide a graphical user interface (GUI) that can receive user input that characterizes the print buyer's project.

In some examples, the print buyer's project can be initiated with a project kick-start phase of the print buyer's project. The project kick-start phase could be implemented, for example, as a series of meetings. In some examples, the project kick-start phase can determine a project budget, a project deadline and how to synchronize different components of the print buyer's project. For instance, in the situation where the print buyer's project is implemented as a marketing campaign, the print buyer's project may need to synchronize the distribution of the printed media with television and/or radio advertisements. The project kick-start can also include a definition of each component of the project. For instance, project kick-start can include a definition of a printing component of print buyer's project, including forms of print media (e.g., advertising flyers, brochures, marketing collaterals, targeted and un-targeted direct mailing, large format printed graphical displays or the like), quantity, dimension, substrate, and conceptual design of graphic arts. The definition of the components of the print buyer's project can also include a specification of inter-dependencies among the components and the lead time of each component of the print buyer's project. For instance, in the case of a marketing campaign, the printing component may need to be completed before the launch of the campaign. In some situations, the timing of the launch of the marketing campaign is determined by other factors, such as a major holiday. In one example, a predefined deadline for the printing component of a print buyer's project could be 2 weeks before a given holiday.

A graphic art design phase for the printing component can be initiated upon completing the project kick-start phase. The graphic art design phase can be executed, for example, by an artist (either in-house or contracted) that can render material to be printed (e.g., posters, flyers or the like) to produce a prototype. The material could include, for example, a logo, text, pictures or a combination thereof. The prototype could be, for example, a physical manifestation of the material for the print project and/or a virtual image. In the graphic art design phase, the print demand can be further defined to include the content to be printed, color management, print quality specifications and other printing oriented information, in addition to the quantity, deadline and cost, allowance specified in the project kick-start phase. In some examples, a print buyer 5 may elect to source the graphic art design phase to the PSP or execute graphic art design phase in collaboration with the PSP.

Upon completing the graphic art design phase, a production phase of the printing component of this buyer's project can be initiated. During the production phase, the print buyer 5 can engage with a PSP with the print demand. The PSP can employ the print demand and the graphic art which can be implemented in a digital format, and translate the print demand into a production plan. The production plan may include, a pre-press processing (e.g., translating the graphic art into a printable format), printing, and post-press processing that can include finishing processes such as cutting, laminating and binding. The completed print products can be shipped to locations specified by the print buyer 5. In some examples, the print buyer 5 specifies the shipping methods and shipping carriers. Additionally or alternatively, the print buyer 5 can elect to employ the PSP to provide the shipping service. The print demand can represent the workload; and the print demand is a component of a service negotiation between the print buyer 5 and the PSP. The deadline included in the print demand is another component for the service negotiation. In some examples, the print buyer's budget for the print production and the price quoted by the PSP to fulfill the print demand can be another negotiation component.

In some situations, an on-time completion of the print production can be a high priority for the print buyer's project. For example, in a marketing campaign situation, upon completing the print production phase, a launch phase of the marketing campaign can be initiated. During the launch phase, a local installation team may need to be contracted to install the printed material. For instance, the local installation team can, in some instances hang posters and/or roadside signs, or install the printed material inside a show window of a department store. The timing of the launch phase can be determined by other factors such as an upcoming national holiday. In a marketing campaign situation, a feedback phase may follow after the completion of the launch phase. The feedback phase can be implemented, for example, as a series of questionnaires provided to generate feedback that can be an indication of the effectiveness of the marketing campaign project.

In other examples, the print buyer's project may involve different components and/or different phases. For instance, in one example of a print buyer's project, a university may need to produce course material to be distributed to students before a semester starts. Such a print buyer's project can involve engaging with faculty to author the content, and engage with PSP to print the content, bind the printed pages and ship the printed material to the university before the first day of the class. In still other examples, additional phases and/or components of the print buyer's project can be implemented. For instance, during a book publishing, a peer review phase may be needed. In the present examples, a print buyer's project can correspond to any of these examples such that the phases in the print buyer's project can be tailored for the specific needs of a particular print buyer's project.

The client marketplace agent 14 can receive (e.g., via a GUI) project data that characterizes each phase of the print buyer's project. The project data could be provided from the first client computer 12 in response to user input. For instance, in some examples, the client marketplace agent 14 can receive the project budget, the project deadline, and specification and parameters of each phase and/or component of the print buyer's project and the inter-dependencies between each phase and/or component. The project data provided to the client marketplace agent 14 can also characterize a complexity of the print buyer's project. The project data provided to the client marketplace agent 14 can further include a list of locations that will receive print material related to the print buyer's project. In other examples, different information can be received in addition to or as an alternative for the project data. One component of the project data is a print demand. The print demand can include the payload (e.g., quantity and quality of the print product, digital art files), potential ancillary services that the print buyer 5 may elect to source to PSP, and budget allowance.

A data manager 16 stored in the memory 8 can include a security policy and enforcement module to control the access rights of the project data in a database 26. The database can be implemented, for example, as volatile or non-volatile memory (e.g., RAM, a hard drive, flash memory or the like). In some examples, the first client computer 12 can also provide a list of PSPs 18 (e.g., security preferences of each of the M number of print buyers 5) to the data manager 16 of the memory 8 that are granted permission to view the project data stored in the database 26 and/or data derived from the project data. In some examples, the first print buyer 5 (e.g., print buyer 1) via the first client computer 12 can grant permission to view all of the project data, or some subset thereof. In the present examples, it is presumed that each of N number of PSPs 18 is included in the list of PSPs 18, where N is an integer greater or equal to one. In other examples, a subset of the N number of PSPs 18 can be included in the list of PSPs 18.

In a similar manner, each of the N number of PSPs 18 can provide the security policy and enforcement module of the data manager 16 with a list of the print buyers 5 (e.g., security preferences of each PSP 18) that are granted permission to view a simulation model of each of the N number of PSPs 18. Accordingly, the data manager 16 can provide the print buyers 5 with a simulation model (e.g., an XML file) for each of the N number of PSPs 18 that have given authorization to the print buyers 5. The simulation model of a PSP documents this PSP's capability and capacity to fulfill certain types of the print services. A simulation model may include list of the production equipments, workforce makeup, cost and operational policy. Coupled with historical data stored in the database 26, as well as and attributes of a given PSP 18, the simulation model provided can be employed to forecast of the given PSP's 18 performance with regard to a particular print demand that a print buyer 5 may elect to engage with the given PSP 18 at a future time that the print demand is assigned to the given PSP 18. A print buyer 5 can employ the simulation model of a given PSP 18 to forecast the lead time, cost and other performance parameters of the given PSP 18 for the given the print demand of the print buyer 5. A print buyer 5 can employ this type of information to aid the selection of a PSP. The client computer 12 can analyze/modify the simulation model for a given PSP 18 to determine the likelihood that the given PSP 18 will be able to provide adequate services to facilitate the print production phase (or some portion thereof) of the print buyer's project.

A simulation engine 20 stored in the memory 8 can receive the project data from the database 26 and can employ a stochastic discrete event model to simulate the print buyer's project including each component and each phase (or some portion thereof) and their inter-dependency of the print buyer's project to generate a simulated print buyer's project. In some examples (e.g., an advertising campaign), the simulated print buyer's project can include data characterizing a simulated campaign kick-start phase, graphic art design phase, production phase, launch phase and feedback phase of the advertising campaign. In other examples, the simulation engine can simulate more, less or different phases to simulate the print buyer's project. The simulated print buyer's project can include, for example, information characterizing a print demand corresponding to the print buyer's project, which can be referred to a simulated print demand. The simulated print demand can characterize, for example, a number of copies of material to be printed, dates and locations for printing and/or shipping the material, as well as specifications related to the printing of the material (e.g., colors, resolutions, shipping locations, substrate types or the like), and the budget allowance for the production phase. In some examples, the simulated print demand can additionally or alternatively characterize ancillary services to be performed such as local installation of posters and/or road signs. In some examples, the simulated print buyer's project can include a simulated fulfillment of the a print demand that can be based on a simulation of fulfillment of the simulated print demand at one or more PSPs 18 of the plurality of PSPs 18.

In some examples, the first client computer 12 can provide the simulation engine 20 with a PSP simulation model. In such a situation, the PSP simulation model can be employed to simulate the production phase of the print buyer's project based on specifications defined therein to generate the simulated print buyer's project. In such a situation, the simulation engine 20 can employ both the project data and PSP simulation model to simulate the print buyer's project including kick-start phase, the graphic art design phase, the production phase, the launch phase and the feedback phase of the print project (or some subset or superset thereof). The simulation engine 20 can provide the client computer 12 with the simulated print buyer's project. The simulated print buyer's project can include the simulated print demand and the simulated fulfillment of the print demand. In some examples, the print buyer's project data can be documented as an XML file. In some examples, the simulated results of the print buyer's project can be stored m the database 26 such that the simulated print buyer's project can be analyzed and/or modified. Both the print buyer's project data and the simulated print buyer's project can also be stored in the database 26.

Additionally, an analyzer 22 stored in the memory 8 can access the database 26 to retrieve the simulated print buyer's project and can generate client prediction data that includes simulated performance metrics such that the print buyer project can evaluate the client prediction data to determine if the goals of print buyer's project are met. The performance metrics of the client prediction data can include, for example, an estimated timeframe for each of the phases of the print buyer's project and a potential cost. The client prediction data can be provided to the first print buyer 5 via the client marketplace agent 14 of the first client computer 12.

The data manager 16 can also communicate with the N number of PSPs 18 that can receive and fulfill print demands. Each PSP 18 can include a PSP computer 23 with a PSP marketplace agent 24 executing thereon that communicates with the data manager 16 over the network 4. For purposes of simplification of explanation, only the PSP computer 23 and the PSP marketplace agent 24 included in PSP 1 of the PSPs 18 is shown and described herein, but it is to be understood that PSPs 2−N of the PSPs 18 can also include a PSP computer 23 and a PSP marketplace agent 24. In some examples, the PSP marketplace agent 24 can operate in a manner similar to the client marketplace agent 14.

The attributes describing the fulfillment capability of each PSP 18 can be categorized as static attributes and dynamic attributes. The static attributes can refer to attributes that change over long period of time such as printing options at each PSP 18. The printing options can include but are not limited to format, color, finishing, ink type, substrate, language, and additional ancillary services or the like. In some examples, printing options can change if a new type of machine is added to a given PSP 18 and/or the given PSP 18 elects to provide new types of printing and/or finishing functions. Additionally, the static attributes for each PSP 18 can also characterize a number of printing presses at a given PSP 18.

The dynamic attributes of each PSP 18 can refer to attributes that can change relatively rapidly during each of the PSPs 18 daily production. The dynamic attributes can be based, for example, on outstanding demands at a given PSP 18, current workload and current utilization of the resources in the given PSP 18, current processes, failure rates of the resources and processes or the like. The dynamic attributes can provides a current snapshot of the given PSP's 18 current capacity and capability for print demands. The dynamic attributes for the given PSP 18 can include, for instance, a dynamic capacity that can increase for the given PSP, if the given PSP has relatively few and/or small print, demands outstanding, or the resources are running at lower-than-normal utilization. By contrast, the dynamic capacity for the given PSP 18 can decrease if a relatively large number of print demands and/or a complex print demand are provided to the given PSP 18.

Each PSP 18 can provide and/or update static attributes to the PSP marketplace agent 24 on a relatively infrequent basis (e.g., once or twice a year). In some examples, the static attributes can be provided/updated in sync with strategic capacity planning of each PSP 18. In response, the PSP marketplace agent 24 can provide the static attributes to the data manager 16, which can store the static attributes for a given PSP 18 in a PSP record associated with the given PSP 18, which PSP record can be stored in the database 26. Although FIG. 1 illustrates the database 26 as being integrated with the marketplace system 6, in other examples, the database 26 could be external to the marketplace system 6 and accessible via the network 4.

Additionally, the dynamic attributes of the given PSP 18 can change with relatively high frequency. For instance, a number of outstanding demands can vary from day to day. During a peak printing season, key resources (for instance, printing presses) in the given PSP 18 may be operating at very high utilization rates. Accordingly, in some examples, in between times that the static attributes for the given PSP 18 are updated (e.g., once a day) each PSP 18 (or some portion thereof) can provide the dynamic attributes to the PSP marketplace agent 24, which in turn can communicate the dynamic attributes to the data manager 16. Such an update of the dynamic attributes can be carried out in an automated fashion through software. For example, the PSP marketplace agent 24 can access a production surveillance software system in the given PSP 18 and employ an application programming interface (API) to automatically query the dynamic attributes of the given PSP 18 either periodically (through a pre-specified window, for instance, every 12 hours) or on-demand. Upon receipt of the dynamic attributes from a given PSP 18, the data manager 16 can store the dynamic attributes in the PSP record associated with the given PSP 18.

The print demand, either an actual (e.g., real) print demand provided by a print buyer 5 or a simulated print demand generated by the simulation engine 20 can be provided to the data manager 16. In some examples, the data manager 16 can provide the print demand to a PSP marketplace agent 24 in each of the PSPs 18 (or a subset thereof) that have been granted access to do so by the print buyer 5 via the first client computer 12. In such a situation, a given PSP 18 can generate a targeted advertisement that could be implemented, for example, as a vertical solution. For instance, the given PSP 18 can generate a vertical solution for printing a particular type of material (e.g., business cards, books, magazines, advertising material or the like). In such a situation, the vertical solution can include a PSP simulation model that is employable by the first client computer 12 to simulate fulfillment of a print demand. The targeted advertisement can include information that can entice the print buyer 5 associated with the print project to select the given PSP 18 to fulfill the print demand corresponding to the simulated print demand. Such information can include, for example, price, execution time, a demand history that characterizes a business history with the print buyer 5 or the like. The information can also include a customer satisfaction rating that can characterize feedback provided to the given PSP 18 upon execution of other print demands. In some examples, the information can also include an alternative simulated print demand (e.g., a vertical solution) for fulfilling the print demand corresponding to the simulated print demand. The targeted advertisement can be provided via the PSP marketplace agent 24 and the data manager 16 to the client marketplace agent 14 of the first client computer 12.

Additionally, in some examples, the analyzer 22 can provide the data manager 16 with client comparative engagement data that characterizes alternative outcomes for different engagement scenarios. To generate the client comparative engagement data, the analyzer 22 can employ the print demand (either an actual print demand provided by the print buyer 5 or a simulated print demand generated through simulating the print buyer's project) to simulate print production (e.g., print and finishing) of material for the corresponding print demand on each of the N number of PSPs (or some portion thereof).

The analyzer 22 can evaluate the client comparative engagement data to select a recommended PSP 18 of the N number of PSPs 18 to fulfill the print demand corresponding to either the actual print demand provided by the print buyer 5 or the simulated print demand generated through simulating the print buyer's project. To determine the recommended PSP 18, in some examples, the analyzer 22 can estimate the dynamic attributes of each PSP 18 at a future state when the actual print demand for the print buyer's project will be fulfilled. For instance, as noted, the print demand can include a date of printing and a date of shipping material for the demand. The analyzer 22 can employ the static and dynamic attributes that describe the capability and capacity of each PSP 18, as well as historical data stored in the database 26 to estimate the dynamic attributes of each PSP 18 at a point in the future defined by the date of printing and the date of shipping in the print demand. The selection of the recommended PSP 18 can also be based on an engagement history between each of the N number of PSPs 18 and this print buyer 5. The selection of the recommended PSP 18 can also factor in the ratings given to each of the N number of PSPs 18 by other print buyers 5 (e.g., print buyers 2−M). The analyzer 22 can provide the client marketplace agent 14 with an engagement recommendation that identifies the recommended PSP 18. The engagement recommendation provided by the analyzer 22 can also include an estimated price and lead time for fulfilling this print demand by the recommended PSP 18.

The data manager 16 can provide the targeted advertisement provided from the given PSP 18 to the client marketplace agent 14 of the first client computer 12. Additionally, the analyzer 22 can provide the client marketplace agent 14 with the client prediction data, the client comparative engagement data and the client recommendation data. The client marketplace agent 14 can combine the targeted advertisement, the client prediction data, the client comparative engagement data and the client recommendation data to provide client marketplace data. The client marketplace agent 14 can provide the client computer 12 with the client market data. In some examples, the client, computer 12 can receive the user input that characterizes a selection of a PSP 18 identified in the client market data, which PSP 18 can be referred to as a selected PSP 18. Upon such a selection, the client computer 12 can provide the client marketplace agent 14 with selection data characterizing the selected PSP 18. In some examples, the client marketplace agent 14 can generate a binding contract between the print buyer 5 and the selected PSP 18 based on the selection data. Additionally or alternatively, the print buyer 5 may elect to defer the decision related to the selection of the PSP 18 until a time near the production phase of the print buyer's project.

Additionally, a given PSP 18 (via the PSP marketplace agent 24) can send a request to the data manager 16 for PSP market data. In response, the data manager 16 can provide the simulation engine 20 with print demand data (either an actual print demand provided by the print buyer 5 or a simulated print demand generated through simulating the print buyer's project). The demand data can include a plurality of print demands that includes a print demand from each of the M number of print buyers 5 that have authorized a given PSP 18 to do so, such that the demand data can be based on the security preferences of each of the print buyers 5. The simulation engine 20 can simulate fulfillment of the print demand at the given PSP 18 for each of the plurality of print demands. As one example, the simulation engine 20 can access the database 26 to retrieve the PSP record corresponding to the given PSP 18 that includes the static and dynamic attributes of the given PSP 18. Additionally, the simulation engine 20 can access the historical data in the database 26 to simulate the fulfillment of the plurality of print demands. Simulation results generated from the simulation of the plurality of print demands for the given PSP 18 can be referred to as PSP simulation results. In some examples, the PSP simulation results can be saved in the database 26. In some examples, the PSP simulation results can be provided to the given PSP 18 and the analyzer 22.

The analyzer 22 can generate PSP prediction data based on the PSP simulation results. The PSP prediction data can include simulated performance metrics that characterizes fulfillment of each of the plurality of print demands at the given PSP 18. In some examples, the performance metrics can include operational cost, lead time, utilization of bottle neck resources or the like. Additionally, the analyzer 22 can employ the PSP simulation results and/or the PSP prediction data to generate PSP comparative engagement data that can characterize various scenarios of fulfillment of each of the plurality of print demands, or some subset thereof at the given PSP 18. Further, the analyzer 22 can generate PSP recommendation data based on the comparative engagement data to recommend a print demand that the given PSP 18 should attempt to fulfill, in some examples, the recommendation data can include a list of recommended print demands for the given PSP 18. The recommendation data can also be based on an engagement history between the given PSP 18 and a print buyer 5 associated with each of the plurality of demands simulated by the simulation engine 20 for the given PSP 18.

The analyzer 22 can provide the PSP prediction data, the PSP comparative engagement data and the PSP recommendation data to the PSP marketplace agent 24 of the given PSP 18. The PSP marketplace agent 24 of the given PSP 18 can combine the PSP prediction data, the PSP comparative engagement data and the PSP recommendation data to generate PSP market data for the given PSP 18. The given PSP 18 can analyze the PSP market data to generate the aforementioned targeted advertisement for each of the M number of print buyers 5, or some subset thereof.

By employment of the system 2, each of the M number of client computers 12 can be provided an estimated time frame and cost for completing the different phases of a print buyer's project. Additionally, each of the M number of print buyers 5 can be provided with a targeted advertisement and a recommendation for fulfilling a print demand corresponding to the print buyer's project. In this manner, each of the M number of print buyers 5 can make an informed decision when selecting a PSP 18 to fulfill a print demand for the print buyer's project. Additionally, each of the PSPs 18 can generate the targeted advertisement to provide to each of the M number of print buyers 5 in a manner described herein. Furthermore, the security policy and enforcement module of the data manager 16 can ensure that only the print buyers 5 authorized to do so can access information related to each of the PSPs 18. Similarly, the security policy and enforcement module of the data manager 16 can ensure that only the PSPs 18 authorized to do so can access information related to each of the M number of the print buyers 5.

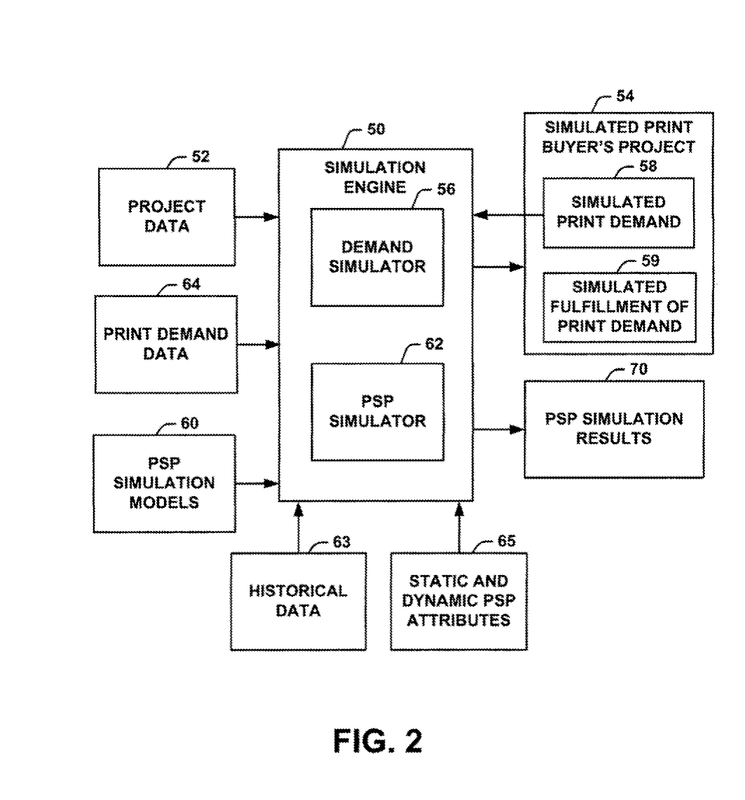

FIG. 2 illustrates an example of a simulation engine 50 that could be employed, for example, as the simulation engine 20 illustrated in FIG. 1. The simulation engine 50 can receive a print buyer's project data 52 from a client marketplace agent, such as the client marketplace agent 14 illustrated in FIG. 1. In one example, the project data 52 could be provided in response to a questionnaire provided by the client marketplace agent regarding a project associated with the print buyer. The project data 52 can characterize the print buyer's project. For instance, the project data 52 can characterize a project specification, a lead time, a budget and a complexity of a project, or some subset or superset thereof.

The simulation engine 50 can employ the project data 52 and a stochastic discrete event model to determine a simulated print buyer's project 54. In some examples, the simulated print buyer's project 54 can include data characterizing a project kick-start phase, a graphic art design phase, a production phase, a launch phase and a feedback phase for the print buyer's project. In other examples, more or less phases in the project can be simulated, based on the nature of the print buyer's project.

In some examples, the simulation engine 50 can include a print demand simulator 56 that can generate a simulated print demand 58 for the simulated print buyer's project 54. The simulated print demand 58 can characterize a print demand that could be employed to fulfill, the production phase (e.g., printing, finishing and shipping) of the print buyer's project. The simulated print demand 58 can be provided to a PSP simulator 62 of the simulation engine 50. The PSP simulator 62 can employ PSP simulation models 60, historical data 63 as well as a static and dynamic attributes 65 from a PSP to simulate fulfillment of the simulated print demand 58 at the PSP to provide a simulated fulfillment of a print demand 59. In some examples, a print buyer can provide actual print demand data through the client marketplace client agent. In such a situation, the PSP simulator 62 can simulate the fulfillment of the actual print demand data 64 provided by the print buyer at each of a plurality of PSPs or some subset thereof, based on security preferences of each of the PSPs to generate the simulated fulfillment of the print demand 59. Additionally or alternatively, the PSP simulator 62 can simulate the fulfillment of the simulated print demand at each of a plurality of PSPs or some subset thereof, based on security preferences of each of the PSPs to generate the simulated fulfillment of the print demand 59. The data characterizing the simulated fulfillment of the print demand 59 can be included in the simulated print buyer's project 54. The simulated print buyer's project 54, including the simulated print demand 58 and the simulated fulfillment of the print demand 59 can be provided to an analyzer.

Additionally, in some examples, the simulated print buyer's project 54 can be provided to a client computer (e.g., via a client marketplace agent, such as the client marketplace agent 14 illustrated in FIG. 1). In some examples, the print buyer's project data 52 can be documented as an XML file. In some examples, the simulated print buyer's project 54 can be stored in a database. In this manner, the client computer (or another system) can analyze the simulated print buyer's project 54 to ensure the accuracy of the simulated print buyer's project 54. Additionally, the client computer (or another system) can employ the analysis of the simulated print buyer's project 54 to select PSPs.

In some examples, the client computer can also provide the simulation engine 50 with multiple PSP simulation models 60 that could be employed by a PSP simulator 62 of the simulation engine 50 to simulate the production phase of the print buyer's project that are fulfilled by the selected multiple PSPs. This situation may occur, for instance, when a particularly complex production phase is needed. For instance, in some print buyer's projects, it may be efficient to have multiple PSPs produce (e.g., print, finish and ship) material for the print buyer's project.

In some examples, the simulation engine 50 can receive print demand data 64 that can include a plurality of print demands generated for a plurality of different print buyers and/or plurality of simulated print demands 58 generated for plurality of different simulated print buyer's projects 54. The print demand data 64 and/or simulated print demands 58 can be provided, for example, in response to a request from a PSP. The PSP simulator 62 can employ the PSP simulation models 60, the historical data 63 and the static and dynamic attributes 65 of the PSP to simulate fulfillment of each of the plurality of print demands at the PSP. The results of the simulation can be provided as PSP simulation results 70. The PSP simulation results 70 can be provided to the analyzer.

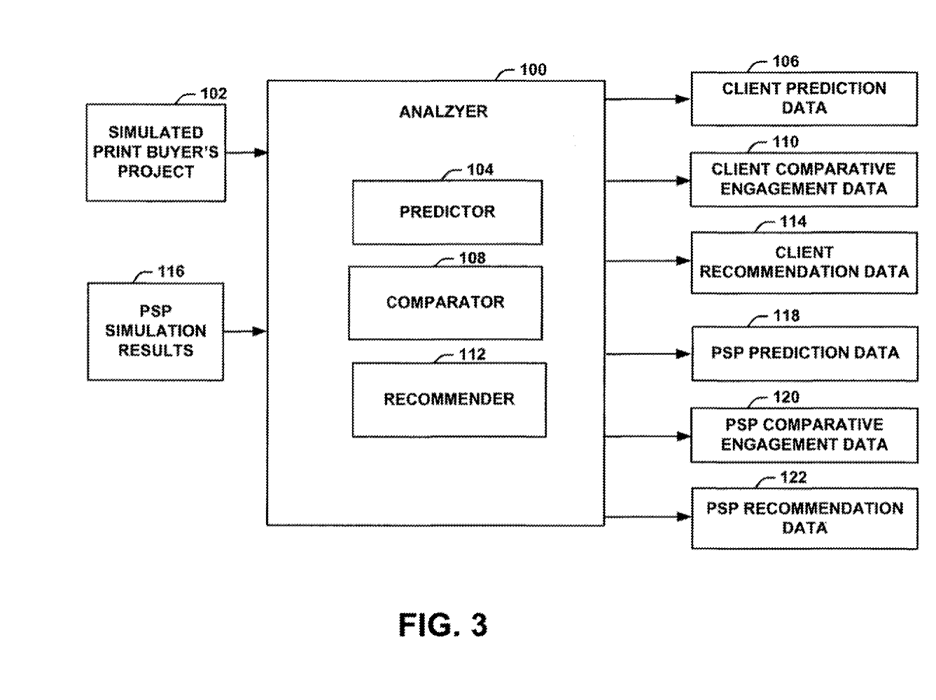

FIG. 3 illustrates an example of an analyzer 100, which could be employed to implement the analyzer 22 illustrated in FIG. 1. The analyzer 100 can receive a simulated print buyer's project 102 provided from a simulation engine. The analyzer 100 can include a predictor 104 that can analyze the simulated print buyer's project 102 to generate client prediction data 106 that can include simulated performance metrics of a PSP to fulfill an associated print demand, which could be either an actual print demand or a simulated print demand, such that the client prediction data 106 can be analyzed (e.g., by a client computer) to determine if goals of a corresponding print buyer's project are met. Additionally, the analyzer 100 include a comparator 108 that can generate client comparative engagement data 110 that characterizes an analysis of outcomes of different possible engagement scenarios. The client comparative engagement data 110 can include, for example a comparative analysis of simulating the print buyer's project 54 using different PSPs to fulfill the print demand (either an actual or simulated print demand) at each of the plurality of PSPs, or some subset thereof. In some examples, such a subset could be defined by a print buyer's project data and controlled by a security policy and enforcement module of a data manager. To determine the client comparative engagement data 110, the comparator 108 can estimate (e.g., forecast) the overall cost and lead time of the simulated print buyer's project 102 accounting for the dynamic capabilities of each of the PSPs at a time of production (e.g., printing, finishing and shipping) for the print demand corresponding to either the actual print demand provided by the print buyer or the simulated print demand generated for the simulated print buyer's project 102.

Additionally, the analyzer 100 can include a recommender 112 that can analyze the client comparative engagement data 110 to generate client recommendation data 114 that includes a recommended PSP to fulfill the print demand corresponding to the simulated print buyer's project 54. Determination of the client recommendation data 114 can include, for example, analysis of the client comparative engagement data 110 to determine which PSP is most likely to provide an optimal solution to the print demand corresponding to the simulated print buyer's project 102. In some examples, the recommended PSP may actually be multiple PSPs. In such a situation, the client recommendation data 114 could identify the multiple PSPs and specify which fraction of a workload of the print demand corresponding to the simulated print demand 102 should be apportioned to which PSP of the multiple PSPs. In such an example, the sum of each fraction of the print demand apportioned to each of the multiple PSPs can be substantially equal to the total workload of the print demand. For instance, in one example, the recommendation data could specify that a first of the multiple PSPs be apportioned with 50% of the workload of the print demand, while a second of the multiple PSPs could be apportioned with 30% of the workload of the print demand and a third of the multiple PSPs could be apportioned with the remaining 20% of the workload of the print demand.

The analyzer 100 can also receive PSP simulation results 116 from the simulation engine. The PSP simulation results 116 can characterize a simulated fulfillment of a print demand by a PSP for a plurality of print demands based on either an actual print demand provided by the print buyer or a simulated print demand generated for the simulated print buyer's project 102. The PSP simulation results 116 can be analyzed by the predictor 104 of the analyzer 100 to generate PSP prediction data 118. The PSP prediction data 118 can include performance metrics (e.g., operational cost, lead time, utilization of bottle neck resources or the like) for each of the print demands of the plurality of print demands.

Additionally, the comparator 108 can generate PSP comparative engagement data 120 that can characterize a plurality of engagement scenarios for the PSP. For instance, the PSP comparative engagement data 120 can include data characterizing a simulated fulfillment of different subsets of the plurality of print demands at the PSP. Further, the recommender 112 can generate PSP recommendation data 122 that recommends a print demand or a list of print demands for the PSP. In some examples, the list of print demands for the PSP can include a list of simulated print demands and/or actual print demands provided by print buyers that are selected based on the static and dynamic attributes of the PSP, the characteristics of each print demand in the list of print demands, an engagement history between print buyers and the PSP or the like. In some examples, the list of print demands can be a list of demands that are most likely to maximize profits for the PSP.

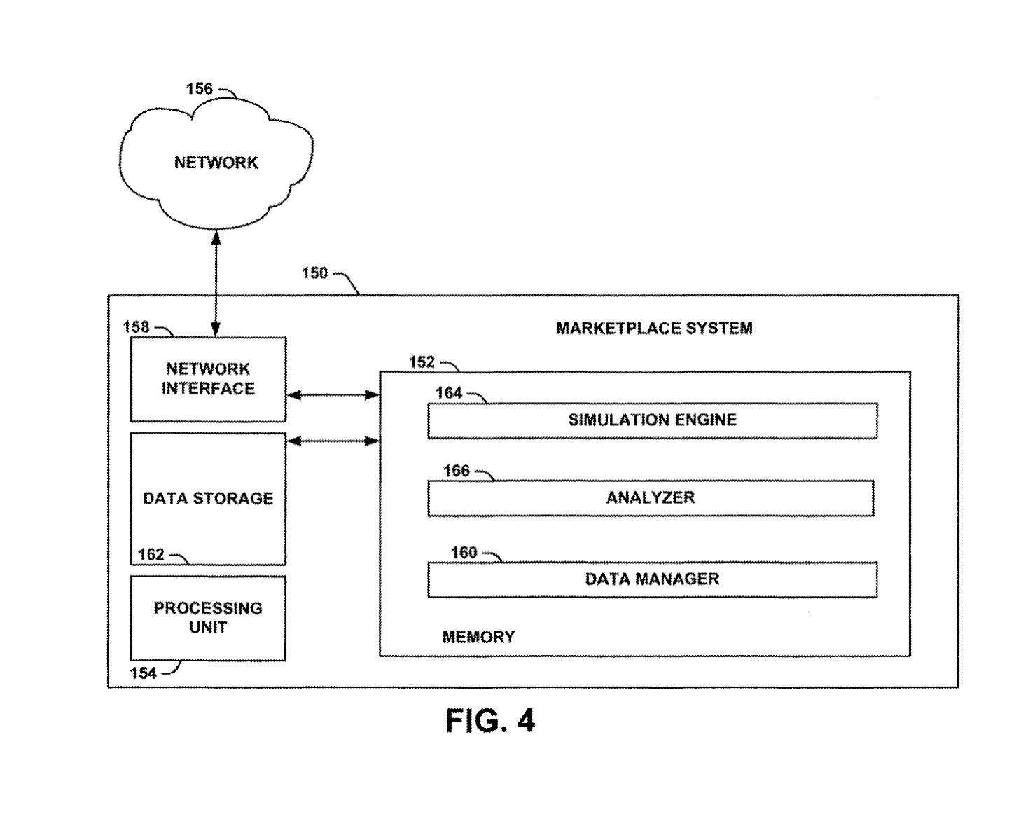

FIG. 4 illustrates an example of a marketplace system 150 that can be utilized to implement, for example, the marketplace system 6 illustrated in FIG. 1. The marketplace system 150 can include a memory 152 for storing machine readable instructions. The memory 152 could be implemented, for example, as random access memory, flash memory, a hard disk, a combination thereof or the like. The marketplace system 150 can also include a processing unit 154 that can access the memory 152 and executes machine readable instructions. The processing unit 154 can be implemented, for example, as a processor core.

The marketplace system 150 can be coupled to a network 156 (e.g., the Internet) via a network interface 158, which could be implemented as a network interface card. The memory 152 can include a data managed 60 that can receive, via the network interface 158, project data from a client computer. The data manager 160 can store the project data in a data storage 162, which data storage can include a database. The data storage 162 could be implemented as volatile or non-volatile memory, such as RAM, a hard drive, flash memory or the like.

The project data can include data that characterizes phases of a print buyer's project. The data manager 160 can be provided with a list of PSPs that can be granted permission to access the project data or a portion of the project data and/or data derived the project data (e.g., a simulated print demand). In some examples, the data manager 160 can provide the client computer with a simulation model from each PSP for which the print buyer has been authorized (e.g., based on the security preferences of each PSP). In such a situation, each PSP can provide a list of print buyers that can access the simulation model for a corresponding PSP. The simulation model from a given PSP can be employed to simulate the operations of the given PSP.

A simulation engine 164 stored in the memory 152 can receive the project data to generate a simulated print buyer's project that can include a simulated print demand and a simulated fulfillment of a print demand. In some examples, the simulation engine 164 can also receive a PSP simulation model and can generate the simulated buyer's print project based on the project data and the PSP simulation model. The simulation engine 164 can employ a stochastic discrete event model to generate the simulated print buyer's project that includes the simulated print demand and the simulated fulfillment of the print demand. Additionally, in some examples, the simulation engine 164 can employ historical data and/or dynamic and static attributes of each PSP (or some subset thereof) to generate the simulated fulfillment of a print demand. The simulated print buyer's project and/or the simulated print demand can be provided to the client computer and stored in the data storage 162. In a similar manner, the marketplace system 150 can receive and process project data from a plurality of different client computers.

The memory 152 can also include an analyzer 166 that can receive static and dynamic attributes for each of N number of PSPs. The static and dynamic attributes that describes the capabilities for each PSP of the N number of PSPs can be stored in a corresponding PSP record. Each PSP record can be stored in the data storage 162. The data manager 160 can provide the project data and/or the print demand for each of the plurality of print buyers to a given PSP for which the given PSP has been granted access. It is to be noted that in the present example, it is presumed that the list of PSPs granted access to the project data for each of the client computers and/or the corresponding print demand includes each of the N number of PSPs.

The analyzer 166 can generate client prediction data based on the simulated print buyer's project. The client prediction data can include performance metrics of the simulation of each phase of the print buyer's project. The analyzer 166 can generate client comparative engagement data based on a simulated fulfillment of a print demand for the simulated print buyer's project at each of the PSPs. The analyzer 166 can generate client recommendation data that includes a recommended PSP selected from the N number of PSPs to fulfill the demand. The client prediction data, the client comparative engagement data and the client recommendation data can be provided to a client marketplace agent of the client computer.

The data manager 160 can receive a targeted advertisement from a given PSP of the N number of PSPs. The targeted advertisement can include information for enticing the print buyer to select the given PSP to produce the print material for the print demand corresponding to the simulated print buyer's project. Such information can include, for example, a price, a delivery date, an engagement history between the given PSP and the print buyer, specifications related to the material print for the demand or the like. Additionally, the targeted advertisement can include an alternate print demand that can characterize an alternative print demand for the print buyer's project.

The data manager 160 can provide the targeted advertisement to the client marketplace agent of the client computer. In some examples, the client marketplace agent can combine the client prediction data, the client comparative engagement data and the client recommendation data to generate client market data. In some examples, the client marketplace agent of the client computer can receive data that characterizes a selection of a PSP identified in the market data, which PSP can be referred to as a selected PSP. In response, the client marketplace agent can generate a binding contract between the print buyer and the selected PSP based on the selection data. Additionally or alternatively, the print buyer may elect to defer the decision related to the selection of the PSP until time near a production phase of the print buyer's project.

In some examples, the data manager 160 can receive a request for PSP market data from a given PSP of the PSPs. In response, the data manager 160 can provide the simulation engine 164 with print demand data extracted from the data storage 162. The print demand data can include a plurality of print demands to which the given PSP has been granted access. The print demand data can include actual print demand data provided by a print buyer or simulated print demand data derived from a simulated print buyer's project. The simulation engine 164 can employ the print demand data to simulate fulfillment of each of the plurality of print demands (actual print demands and/or simulated print demands) included the print demand data at the given PSP to produce PSP simulation results. The PSP simulation results can be provided to the analyzer 166.

The analyzer 166 can generate PSP prediction data that characterizes performance metrics of the fulfillment of each of the plurality of the print demands (either the actual print demand data provided by a print buyer or simulated print demand data derived from a simulated print buyer's project) at the given PSP. Additionally, the analyzer 166 can generate PSP comparative engagement data that can characterize simulation of a plurality of different subsets of the plurality of print demands at the given PSP. Further still, the analyzer 166 can generate PSP recommendation data for the given PSP that includes a list of recommended print demands for the given PSP. The analyzer 166 can provide the PSP prediction data, the PSP comparative engagement data and the PSP recommendation data to a PSP client of the given PSP. The client of the given PSP can, in some examples combine the PSP prediction data, the PSP comparative engagement data and the PSP recommendation data to generate PSP market data for the given PSPs. In some examples, a PSP can analyze the PSP market data to generate the aforementioned targeted advertisement for selected print buyers.

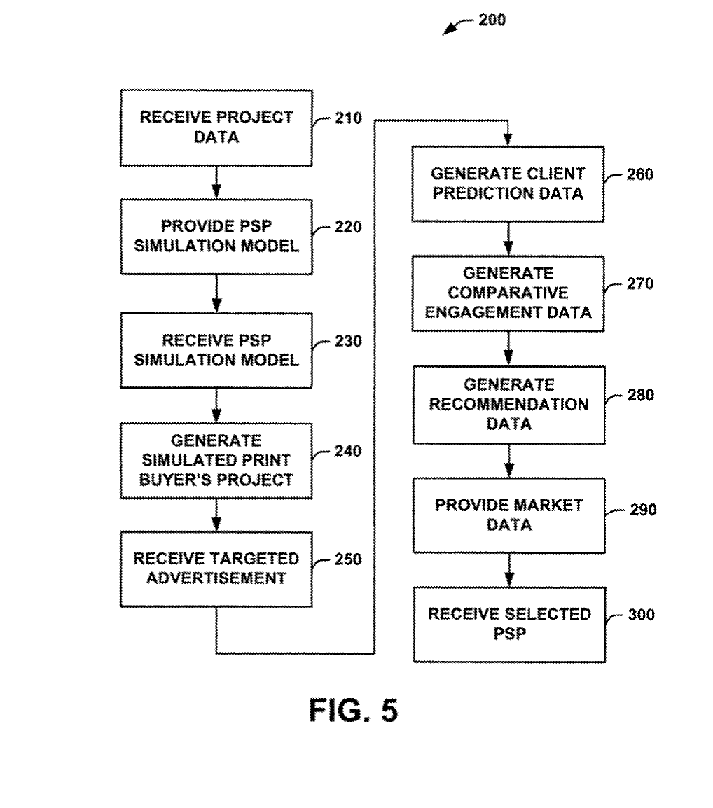

In view of the foregoing structural and functional features described above, example methods will be better appreciated with reference to FIGS. 5-6 and 8. While, for purposes of simplicity of explanation, the example methods of FIGS. 5-6 and 8 are shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method.

FIG. 5 illustrates a flow chart of, an example method 200 for generating a simulated print buyer's project. The method 200 could be executed, for example, by a marketplace system (e.g., the system 2 illustrated in FIG. 1 and/or the marketplace system 150 illustrated in FIG. 4). At 210, project data can be received by a data manager. The project data can include data characterizing a print buyer's project. In some examples, the data manager can also receive a list of PSPs authorized to receive the project data and/or data derived from the project data (e.g., a simulated print demand). At 220, a PSP simulation model can be provided to the print buyer. The PSP simulation model can characterize operations of a given PSP of N number of PSPs. At 230, a PSP simulation model can be received by a simulation engine. The PSP simulation model can include data for simulating fulfillment of a print demand corresponding to the print buyer's project.

At 240 the simulation engine can simulate the print buyer's project to generate a simulated print buyer's project. The simulated print buyer's project can include, for example, a simulated print demand and a simulated fulfillment of a print demand. At 250, a targeted advertisement for the print project can be received at the data manager from a given PSP. The targeted advertisement can include, for example, information (e.g., price, shipping date, engagement history, printing specifications or the like) to entice the print buyer to select the given PSP to produce the print material (e.g., print, finish and ship) for a print demand corresponding to the simulated print buyer's project. Additionally, the targeted advertisement can include an alternate simulated print demand, which can be similar to the simulated print demand.

At 260, an analyzer of the marketplace system can generate client prediction data that can include performance metrics (e.g., an estimated timeframe for each of the phases of the print buyer's project, a potential cost or the like) of a simulation of the print buyer's project, including a project kick-start phase, a graphic art design phase, a production phase, a launch phase and a feedback phase, or a subset or superset thereof. At 270, client comparative engagement data can be generated by the analyzer. The client comparative engagement data can include an analysis of a simulation of fulfillment of the print demand on each of the PSPs identified in the project data. The client comparative engagement data could be based, for example, on the project data, PSP simulation model, and historical data as well as static and dynamic attributes of each of the PSPs identified in the project data. At 280, client recommendation data can be generated by the analyzer. The client recommendation data can include a recommended PSP based on the client comparative engagement data as well as a historical relationship between each of the PSPs and the print buyer.

At 290, client market data can be provided to the client computer. The client market data can include, for example, the targeted advertisement, the client comparative engagement data and the client recommendation data. At 300, a PSP is selected by the print buyer and the selected PSP is received at the data manager. The selected PSP could be, for example, the PSP of the N number of PSPs chosen by the print buyer to fulfill the demand corresponding to the simulated project. In some examples, the selected PSP can be a plurality of selected PSPs, wherein each of the plurality of selected PSPs can be assigned to produce a predetermined fraction of material for the print buyer's project.

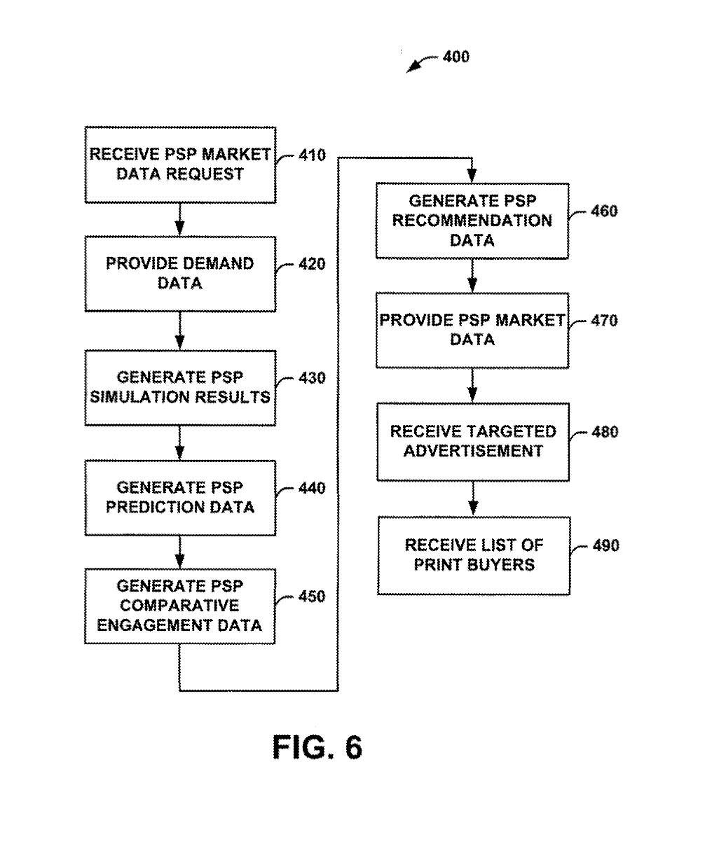

FIG. 6 illustrates a flow chart of an example method 400 for processing a request for PSP market data. The method 400 could be executed, for example, by a marketplace system (e.g., the system 2 illustrated in FIG. 1 and/or the marketplace system 150 illustrated in FIG. 4). At 410, a request for PSP market data can be received from a PSP, at a data manager of the marketplace system. At 420, print demand data can be provided to, a simulation engine of the marketplace system. The print demand data can include, for example, a plurality of print demands to which the PSP has been granted access. At 430, PSP simulation results can be generated by the simulation engine.

At 440, PSP prediction data can be generated by an analyzer of the marketplace system based on the PSP simulation results. The PSP prediction data can characterize a simulation of fulfillment of the plurality of print demands. At 450, PSP comparative engagement data can be generated by the analyzer for the PSP. The PSP comparative engagement data can characterize different engagement scenarios of different subsets of the plurality of print demands. At 460, PSP recommendation data can be generated by the analyzer. The recommendation data can include a list of demands in the plurality of print demands that are most likely to fully maximize profits for the PSP.

At 480, a targeted advertisement provided from the PSP can be received at the data manager. The targeted advertisement can identify a print buyer associated with a print buyer's project. The targeted advertisement can include information including a vertical solution that can entice the print buyer to select the PSP to fulfill a print demand. At 490, a list of print buyers can be received by the data manager. To generate the list of print buyers, in some examples, multiple print buyers can select the PSP to fulfill their print demands. In such a situation, the PSP can engage with the marketplace system and simulate each potential print demand (e.g., action 430). Upon such a simulation, the PSP can determine whether to accept all such print demands or a subset of the print demands to maximize profit. In such a situation, the PSP can generate and provide the list of print buyers that the PSP elects to engage with and fulfill the print demands associated with the list of the print buyers.

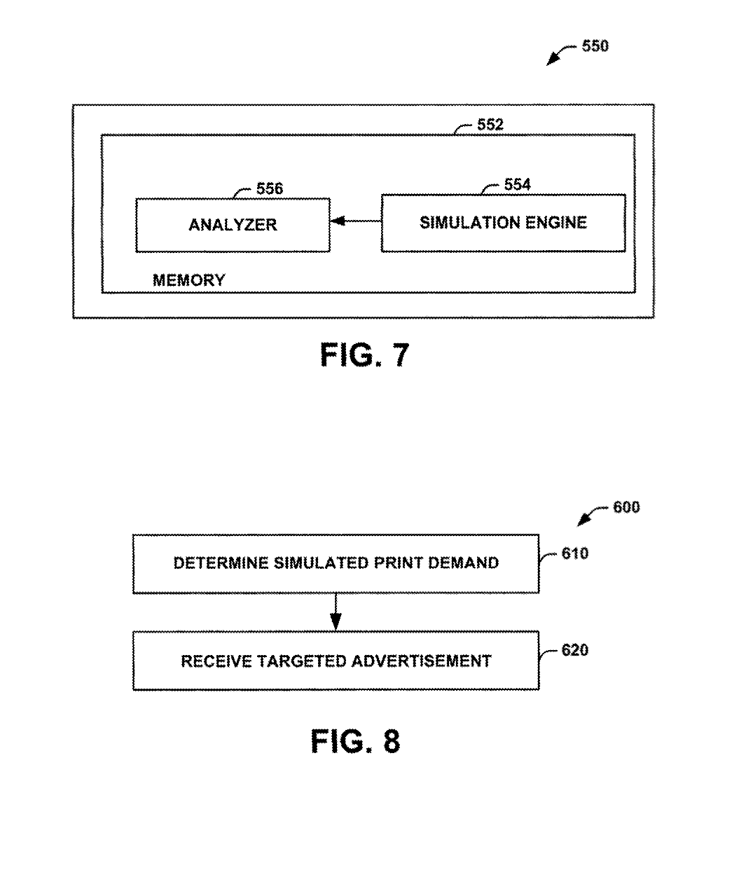

FIG. 7 illustrates an example of a system 550 that includes a computer readable memory 552. The term “computer readable memory” as used herein refers to a medium that participates in providing instructions to a processing unit for execution. The memory 552 can store machine readable instructions. The machine readable instructions 552 can comprise a simulation engine 554 to receive project data characterizing a project of a print buyer. The project can comprise a production of printed material. The simulation engine 554 can also generate a simulated print demand that characterizes a print demand for the printed material for the project. The simulation engine 554 is also to generate print service provider (PSP) simulation results based on print demand data that includes an actual print demand provided from a plurality of print buyers or the simulated print demand generated for the project. The machine readable instructions can also comprise an analyzer 556 to identify a PSP of a plurality of PSPs based on a simulated fulfillment of the print demand at each of the plurality of PSPs.

FIG. 8 illustrates another flowchart of an example method 600 for generating a simulated print demand. The method 600 could be executed, for example, by a marketplace system (e.g., the system 2 illustrated in FIG. 1 and/or the marketplace system 150 illustrated in FIG. 4). At 610, a simulated print demand can be determined (e.g., by a simulation engine) based on project data that characterizes a print buyer's print project. At 620, a targeted advertisement can be received (e.g., at a data manager) from a print service provider (PSP) that includes an alternate simulated print demand for the print buyer's project. The alternate simulated print demand can be similar to the simulated print demand.

Where the disclosure or claims recite “a.” “a first,” or “another” element, or the equivalent thereof, it should be interpreted to include one or more than one such element, neither requiring nor excluding two or more such elements. Furthermore, what have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. A computer readable medium having machine readable instructions comprising:
a simulation engine to:
receive project data characterizing a project of a print buyer, wherein the project comprises a production of printed material;
generate a simulated print demand that characterizes a print demand for the printed material for the project; and
generate print service provider (PSP) simulation results based on print demand data that includes an actual print demand provided from a plurality of print buyers or the simulated print demand generated for the project; and
an analyzer to identify a PSP of a plurality of PSPs based on a simulated fulfillment of the print demand at each of the plurality of PSPs.

2. The computer readable medium of claim 1, wherein the machine readable instructions further comprise a data manager to receive static and dynamic attributes that describe the fulfillment capabilities, capacities and factory production surveillance data relating to a current print production status from each of the plurality of PSPs.

3. The computer readable medium of claim 1, wherein the analyzer is further to recommend an actual print demand and/or a simulated print demand in the plurality of print demands for a given PSP of the plurality of PSPs.

4. The computer readable medium of claim 3, wherein the machine readable instructions further comprise a data manager to receive a targeted advertisement from the given PSP of the plurality of PSPs, the targeted advertisement including information relevant to production of printing material for an actual print demand.

5. The computer readable medium of claim 4, wherein the targeted advertisement includes an alternate simulated print demand for the project of the print buyer.

6. The computer readable medium of claim 1, wherein the identified PSP is multiple PSPs of the plurality of PSPs that are selected by the analyzer to be multiple PSPs based on client comparative engagement data derived from the simulated fulfillment of the print demand at each of the plurality of PSPs.

7. The computer readable medium of claim 1, wherein the machine readable instructions further comprise a data manager to provide a PSP simulation model that is employable to simulate a functionality of a given PSP of the plurality of PSPs.

8. The computer readable medium of claim 1, wherein simulation engine is further to receive a PSP simulation model from a client computer, wherein the PSP simulation model is employed by the simulation engine to simulate production of print material for the project of the print buyer.

9. The computer readable medium of claim 8, wherein the production of print material corresponds to printing and shipping the material for the project of the print buyer at multiple PSPs.

10. The computer readable medium of claim 8, wherein the analyzer is further to provide client prediction data to the client computer that characterizes performance metrics of a simulation of the print buyer's project.

11. The computer readable medium of claim 1, wherein the analyzer is to select a recommended PSP based on a prior engagement agreement between the recommended PSP and the print buyer.

12. A method comprising:
determining a simulated print demand based on project data that characterizes a print buyer's print project; and
receiving a targeted advertisement from a print service provider (PSP) that includes an alternate simulated print demand for the print buyer's project, wherein the alternate simulated print demand is similar to the simulated print demand.

13. The method of claim 12, further comprising:
receiving a PSP simulation model;
employing the PSP simulation model to provide a simulated print buyer's project; and
providing client prediction data that characterizes performance metrics for the simulated the print buyer's project.

14. The method of claim 12, further comprising simulating fulfillment of a plurality of demands at a given PSP to generate PSP simulation results.

15. A computer readable medium having machine readable instructions comprising:
a data manager to:
receive project data that characterizes a print buyer's project from a client computer;
provide a print service provider (PSP) simulation model that is employable to simulate functionality of an associated PSP;
receive static and dynamic attributes of a plurality of PSPs;
control access to the project data based on security preferences of the print buyer;
control access to the static and dynamic attributes of the plurality of PSPs based on security preferences of each of the plurality of PSPs; and
receive a request for PSP market data from a given PSP of a plurality of PSPs;
a simulation engine to:
generate a simulated print buyer's project that comprises:
a simulated print demand that corresponds to a print demand for the print buyer's project; and
a simulated fulfillment of a print demand that characterizes a simulated fulfillment of the simulated print demand at a PSP of the plurality of PSPs; and
generate PSP simulation results for the given PSP based on print demand data that includes a plurality of actual print demands provided by a plurality of different print buyers and a plurality of simulated print demands generated for a plurality of simulated print buyers projects; and
an analyzer to:
generate client prediction data that includes performance metrics of the simulated print buyer's project; and
generate client comparative engagement data based on a simulated fulfillment of the simulated print demand for the print buyer's project at each of the plurality of PSPs;
analyze the client comparative engagement data and an engagement history of each of the plurality of PSPs and the print buyer to generate client recommendation data that includes a recommended PSP of the plurality of PSPs for producing printing material for the print buyer's project;
generate PSP prediction data that includes performance metrics of the PSP simulation results; and
generate PSP comparative engagement data based on a simulated fulfillment of the plurality of print demands including a plurality of actual print demands provided by the plurality of different print buyers and the plurality of simulated print demands generated for the plurality of print buyers' projects;
analyze the PSP comparative engagement data and an engagement history of each of the plurality of PSPs and the plurality of different print buyers to generate PSP recommendation data that includes a recommended print demand of the plurality demands in the print demand data for the given PSP.
